(19) United States
(12) Patent Application Publication
(10) Pub. No.: US 2026/0364803 A1
(43) Pub. Date: Nov. 19, 2026

(54) USING SCENE UNDERSTANDING TO GENERATE CONTEXT GUIDANCE IN ROBOTIC TASK EXECUTION PLANNING

(71) Applicant: GOOGLE LLC, Mountain View, CA (US)

(72) Inventors: Nikhil J. Joshi, Fremont, CA (US); Anthony G. Francis, Jr., Simpsonville, SC (US)

(21) Appl. No.: 19/155,488

(22) PCT Filed: Mar. 1, 2024
(86) PCT No.: PCT/US2024/018110

§ 371 Date: Aug. 11, 2025

Related U.S. Application Data
(60) Provisional application No. 63/449,262, filed on Mar. 1, 2023.

(51) Int. Cl. B25J 9/16; G05B 13/02

(52) U.S. Cl. CPC B25J 9/1697; B25J 9/163; G05B 13/027; G05B 2219/32335; G05B 2219/39001

(57) ABSTRACT

Some implementations relate to utilizing both a large language model (LLM) and a visual language model (VLM) in generating, and at least selectively refining, a plan for the execution of a long-horizon robotic task. Various implementations include processing, using the LLM, a free-form natural language instruction, that describes the robotic task to generate LLM output. In some implementations, the LLM output can reflect natural language that indicates one or more sub-tasks to perform the task. Additional or alternative implementations include processing, using the VLM, one or more instances of vision data capturing the environment of the robot and a VLM prompt that is based on the LLM output, to generate a task conditioned description of the environment. Some implementations additionally or alternatively use the task conditioned description of the environment to refine the one or more sub-tasks based on the current environment of the robot.

### BACKGROUND

Many robots are programmed to perform certain tasks. For example, a robot on an assembly line can be programmed to recognize certain objects, and perform particular manipulations to those certain objects.

Further, some robots can perform certain tasks in response to explicit user interface input that corresponds to the certain task. For example, a vacuuming robot can perform a general vacuuming task in response to a spoken utterance of “robot, clean.” However, often, user interface inputs that cause a robot to perform a certain task must be mapped explicitly to the task. Accordingly, a robot can be unable to perform certain tasks in response to various free-form natural language inputs of a user attempting to control the robot.

### SUMMARY

Implementations described herein are directed towards utilizing both (1) a generative model (such as a large language model (LLM)) and (2) a visual language model (VLM) in generating, and at least selectively refining, a plan for the execution of a long-horizon robotic task (referred to herein as a long-horizon task, a task, etc.). In some implementations, the system can process, using the LLM, a free-form natural language (NL) instruction for the robot to perform a task to generate NL text output that indicates one or more sub-tasks for the robot to perform in furtherance of completing the task). The robot may be unable to perform one or more of the sub-tasks until a prior sub-task is performed and/or an additional action that is not a sub-task is performed.

For example, a user can provide the free-form NL instruction of “I am done, please wipe the table,” indicating that a robot should wipe off a table. The free-form NL instruction can be provided by a user in a variety of ways including NL text input (e.g. provided by a keyboard) and/or a text representation generated based on a spoken utterance provided by the user (e.g., processing audio data capturing the spoken utterance using an automatic speech recognition model to generate the free-form NL instruction). The system can process the instruction using the LLM to generate one or more sub-tasks for the robot to perform the task wipe off the table. For example, the sub-tasks can include: “I would: 1. Go to the table 2. Wipe the table.” The robot will need to navigate to the table (e.g., performance of the first sub-task ‘1. Go to the table’) before the robot can wipe the table (e.g., performance of the second sub-task ‘2. Wipe the table’). In other words, if the robot fails to successfully navigate to the table, the robot will be unable to complete the next sub-task of wiping the table, and similarly will be unable to complete the original log-horizon task in the free-form NL instruction. While the generative model described herein is often referred to as an LLM, this is merely illustrative and is not meant to be restrictive. The generative model can include a variety of machine learning models including an LLM, a sequence-to-sequence model, one or more portions of a trained model (e.g., the decoder portion of an LLM), one or more additional or alternative generative models, and/or combinations thereof.

Additionally or alternatively, the system can generate a prompt for a visual language model (VLM) based on the free-form NL instruction. The VLM prompt can be processed with one or more instances of vision data capturing the environment of the robot to generate a task conditioned summary of the environment (e.g., a summary of the visual observations within the context of the free-form NL instruction). In some implementations, the system can refine one or more of the sub-tasks for performing the task based on processing the free-form natural language instruction and the task conditioned description of the environment using the LLM.

In continuance of the example of processing the free-form NL instruction of “I am done, please wipe the table,” the robot can determine there is an object on the table which is preventing it from wiping the table. For example, the robot can process one or more instances of vision data capturing the environment of the robot using one or more machine learning models (e.g., an object identification model, etc.) to identify the table, the object on the table, etc. In some implementations, the one or more instances of vision data capturing the environment of the robot (including the object on the table) and the VLM prompt can be processed using the VLM to generate a task conditioned summary of the environment which indicates the object is on the table. The robot can process the task conditioned summary of the environment and the free-form NL instruction using the LLM to generate refined NL text output indicating one or more refined sub-tasks. For example, the system can generate the refined sub-tasks of “I would 1. Go to the table 2. Ask for help with table clearance 3. Wipe the table.” In other words, the sub-tasks would be refined to include a request for help clearing the table.

In some implementations, the robot can request help from one or more additional or alternative robots. For example, the robot requesting help may be unable to remove the object from the table because it does not have a grasping end effector (and instead has a wiper end effector for wiping the table). In some implementations, the robot can request help from an available additional robot that has a grasping end effector and can remove the object from the table. Additionally or alternatively, the robot can ask for help from a human operator to remove the object from the table. In other words, when facing a failure, the robot can replan for recovery (e.g., ask an additional robot for help removing the object) and upon receiving help, return to executing the original task. For example, after the additional robot removes the object from the table, the robot can determine the surface of the table is free of objects and can be wiped off. The robot can then proceed with wiping off the table to successfully complete the task.

In some implementations, the robot can identify one or more robotic skills performable by the robot, where each of the one or more robotic skills has a corresponding skill description. For example, the robot with the wiping end effector can perform a wiping skill with a corresponding skill description of “wipe the table.” Additionally or alternatively, the additional robot with the grasping end effector can perform a manipulation skill with a corresponding skill description of “clear the table.” In some implementations, the robot can determine to implement a given robotic skill based on comparing the refined natural language text output (indicating the one or more refined sub-tasks for performing the task) to the skill description of the given robotic skill.

For example, the system can process the refined natural language text output using a word embedding model (e.g., word2vec, GloVe, ELMo, BERT, one or more additional or alternative word embedding models, and/or combinations thereof) to generate a word embedding representation of the refined NL text output which projects the refined NL text output into a shared vector space. In some implementations, the system can compare the word embedding representation of the refined NL text output with one or more word embedding representations corresponding to available robotic skills in the shared vector space. In some of those implementations, the system can determine the robotic skill to implement based on the comparing (e.g., selecting the robotic skill description (and corresponding robotic skill) with the word embedding representation that is the shortest distance from the word embedding representation of the refined NL text output).

As an additional or alternative example, the system can compare the refined NL text output with one or more skill descriptions based on processing the refined NL text output and the one or more skill descriptions using a generative model (e.g., the large language model) to generate natural language output indicating which (if any) of the one or more robotic skills the system should implement in furtherance of the refined sub-task(s).

Subsequent to causing the robot to implement the given robotic skill in the environment, the robot can capture one or more additional instances of vision data of the environment of the robot (i.e., vision data capturing the environment of the robot after causing the robot to implement the given robotic skill). A further VLM prompt can be generated based on the refined NL text output which indicates the one or more refined sub-tasks. In some implementations, the system can process the further VLM prompt and the refined NL text output using the VLM to generate a further task conditioned description of the environment. For example, the further task conditioned description of the environment can indicate the object has been removed from the surface of the table.

Additionally or alternatively, the system can process the free-form NL instruction and the further task conditioned description of the environment using the LLM to generate further refined NL output indicating one or more further refined sub-tasks. For example, the system can process the free-form NL instruction of “I am done, please wipe the table” and the further task conditioned description of the environment indicating the object has been removed from the table (e.g., the object has been removed by the additional robot and/or the human operator) using the LLM to generate further refined NL text output indicating the further sub task of ‘3. Wipe the table’ for performing the original task of “I am done, please wipe the table.” The system can identify the wiping skill with the corresponding skill description of “wipe the table.” In some implementations, the system can determine to implement the wiping skill based on comparing the further sub-task of ‘3. Wipe the table’ with the skill description of “wipe the table.”

Accordingly, various implementations set forth techniques for visual affordance detection and error recovery for a robot in the performance of a task. The system can generate a plan for task execution based on processing a free-form NL instruction using an LLM, where the plan includes NL text output indicating one or more sub-tasks for performing the task. The use of generative models, such as an LLM, enables the robot to plan and execute tasks based on diverse human instructions. However, these plans may not be grounded in the environment of the robot. In some implementations, the system can process vision data capturing the environment of the robot using a VLM to generate a task conditioned description of the environment, where the task conditioned description of the environment can be processed using the LLM to generate a refined plan for task execution based on the current environment of the robot.

In some implementations, the refined plan for task execution can enable the robot to replan and recover when obstacles are encountered during task execution prior to proceeding to the next sub-task for completing the original task. Computing resources (e.g., battery, processor cycles, memory, etc.) can be conserved by determining whether a sub-task was successfully completed before proceeding to the next sub-task in accordance with implementations described herein. In some implementations, the system can ask for help from one or more additional robots and/or one or more additional human operators to perform the sub-task or perform an action not included in the original task execution plan. This allows the robot to flexibly adapt to obstacles in the environment during the planning and execution of long-horizon tasks.

The above description is provided as an overview of only some implementations disclosed herein. These and other implementations are described in more detail herein, including in the detailed description and the claims.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein

### BRIEF DESCRIPTION OF THE DRAWINGS

FIG. 1 illustrates an example of a human providing a free-form (FF) natural language (NL) instruction to an example robot.

FIG. 2 illustrates a simplified birds-eye view of an example environment in which the human and the robot of FIG. 1 are located, and illustrates an example vision data instance capturing the environment.

FIG. 3 is a flowchart illustrating an example process in accordance with some implementations disclosed herein.

FIG. 4 is a flowchart illustrating another example process in accordance with some implementations disclosed herein.

FIG. 5 is a flowchart illustrating another example process in accordance with some implementations disclosed herein.

FIG. 6 schematically depicts an example architecture of a robot.

FIG. 7 schematically depicts an example architecture of a computer system.

### DETAILED DESCRIPTION

Robots today can exploit the rich world knowledge of large language models to chain simple behavioral skills into long-horizon tasks. However, robots often get interrupted during long-horizon tasks due to primitive skill failures and dynamic environments. In some implementations, the system can include a visual affordance detection and error recovery (VADER) framework—e.g., a plan, execute, detect framework with seeking help as a new skill that enables robots to recover and complete long-horizon tasks with the help of humans and/or other robots. In some implementations, VADER leverages visual question answering (VQA) modules to detect visual affordances and recognize execution errors. Additionally or alternatively, the system generates prompts for a language model planner (LMP) which decides when to seek help from another robot or human to recover from errors in long-horizon task execution. In some implementations, the system can include a mobile manipulator asking for help from another mobile manipulator or another human for completing two long-horizon robotic tasks.

Task and motion planning can be used for solving long-horizon robotic tasks which treats high-level planning and low-level skills as interdependent. Additionally or alternatively, language model planners (LMPs), which use large language models (LLMs) to orchestrate a library of low-level skill primitives, can be used in replacing traditional task planners. For example, LMPs can exploit LLM's rich semantic structure to generate high-level robot plans given diverse human instructions. For example, LMP-based robots can execute plans for instructions like “get me a drink” or “I am thirsty, please help me”, issued in many languages, even if they have not seen this exact instruction in any language, by using LLM knowledge to break these tasks into skills and perform them in the correct causal order.

While LMPs alleviate the need for task planning modules, their language plans are often not fully grounded in the robot's environment, which can make it hard to evaluate whether a skill should be executed (skill affordances) and/or whether a skill has succeeded (error recognition). Incorrectly gauging skill affordances can cause planning errors leading to execution of incorrect skills. In addition, skill failures can disrupt task execution. These issues compound as task horizons become longer: ironically, as a robot becomes more capable, it can fail more often.

For example, LMPs such as SayCan ground language plans in skill affordances that are based on value functions associated with an RL policy used for executing each skill. While this promotes selecting a plan with skills with high affordances, LMPs often lack awareness of the current state. If a robot breaks its gripper or its workspace is disrupted, many LMPs cannot recognize these dynamic changes and might proceed with an infeasible plan. Additionally or alternatively, while LMPs use affordances as pre-conditions for selecting the next skill, they can generally assume success at previous skill execution lacking the ability to detect errors.

In some implementations, the system can bring environmental cues, such as scene descriptions into the planning loop. For example, extensions of SayCan (e.g., such as Inner Monologue) can improve reliability of execution by incorporating a variety of environment feedback into the LMP planning loop. However, while feedback has been shown to be effective, the existing systems typically focus on failures that can be resolved by a single robot. If the problem cannot be resolved given the robot's own capabilities—e.g., a robot gripper breaking—task execution will still fail.

In some implementations, by grounding with their environments, robots can detect their failures and collaborate with other robots and/or humans to course correct through planning. For example, a visual question answering (VQA) system can provide the required grounding mechanism, where natural language summary on a visual observation can be generated within the context of a query. However, multi robot human collaboration can be difficult due to lack of a mechanism for distributed communication that enables agents to post or claim tasks and/or provide assistance to each other.

In some implementations, the system can use a technique called Visual Affordance Detection and Error Recovery (VADER) which uses feedback from affordance and error detection to generate requests for help from other agents and/or humans. In some of those implementations, the system can dynamically detect failures and employ recovery measures, thus enabling it to complete long horizon tasks. Additionally or alternatively, the system can use a cloud-based communication framework to facilitate this assistive collaboration, instantiated with robot agents working alongside humans. In some implementations, the system can effectively plan task execution for a complex, long horizon task, where two robots with differing morphologies (e.g., a first robot with a parallel gripper and a second robot with a wiping tool at its end-effector, etc.) work in collaboration to complete, i.e. the task cannot be done by any one of them alone.

In some implementations, a general robot-environment interaction can be modeled as a Markov Decision Process (MDP) M=(S, A, P, R, γ) defined over the state space S capturing the environment and robot state, the robot action space A, the transition probability P:S×A×S→[0, 1], and a reward function R: S×A→R with a discount factor γ. Executing a policy π:S→A in an environment results in a trajectory, i.e., a sequence of states, actions, and rewards τ={(s₀, a₀, r₀), . . . , (s_{N}, a_{N}, r_{N})}. In some implementations, the system can create an execution policy that optimizes its expected discounted accumulated reward, or return

$$G = {E}_{τ ∼ π} [ {\sum }_{k = 0}^{N} {γ}^{k} {r}_{k} ]$$

over the trajectories that result from following the policy. In reinforcement learning (RL) the policy is learned over the returns received in each trajectory, whereas in behavioral cloning (BC) the policy is learned over expert trajectories that implicitly optimize the return. In model predictive control (MPC), the policy implicitly attempts to achieve high returns by optimizing a proxy cost function over forward rollouts of trajectories based on the state-action transition probability P.

A skill a refers to a sensorimotor primitive described in natural language. In some implementations, every skill σᵢ has an associated policy πᵢ used for executing it. In some implementations, the system does not learn new skills, and can access a library of precomputed policies. Additionally or alternatively, these skills can be created independently (by the system and/or by other sources). For example, an object manipulation policy can be trained using BC with a transformer based architecture, a table wiping policy can be trained with RL, and a navigation policy can use the non-learned MPC.

In some implementations, language model planners (LMPs) can combine the semantic and causal structure of the world embedded in an LLM with the skills acquired by a robot to construct task execution plans from available skills. Language model planning involves using a language model to transform a task instruction T into a larger plan P consisting of a sequence of executable skills as defined earlier. For example, the language model can be used to score a fixed set of language representations of available skills Σ to produce a ranking for the next skill to be executed σₙ in the plan. In some implementations, the LLM ranking scores can be “grounded” by multiplying them with the value functions V(s) associated with the skills as a proxy for their affordances p^{affordance}(σ|s) to obtain what we collectively denote as p^{LMP}(σ|T, s, σₙ₋₁, . . . , σ₀). The skill σ that maximizes p^{LMP} is typically selected to be executed next in the task plan. In some implementations, PaLM can be used as the language model for task planning.

In some implementations, Visual-Language Models (VLM) can leverage the abundant (image, text) paired data to learn bi-encoders that map texts and images to the same embedding space E in an attempt to capture semantics and transfer concepts across these two modalities. In some implementations, VLMs such as CLIP can be used for zero-shot classification capabilities to novel concepts based on these encodings, while other VLMs such as ViLD can distill the vision-text knowledge into open vocabulary object detection and mask prediction models. Additionally or alternatively, PaLI has been used to leverage pretrained LLMs with relatively moderate sized vision models to transfer generalization capabilities acquired by former to the latter. In some implementations, the system can use one or a combination of VLM variants (e.g., CLIP, ViLD, PaLI, etc.) as part of the vision question answering (VQA) systems to answer text queries about images with text answers, V_{QA}:I×T→T.

In some implementations, the system can process (1) a long-horizon task instruction λ in natural language (e.g., “I am done, please wipe the table”), and (2) a library of low-level skills Σ to generate a task and motion plan that executes the long-horizon task λ. In some implementations, the system can use Visual Affordance Detection and Error Recovery (VADER), a plan, execute, detect framework which uses a VQA to verify the execution of each LMP skill before continuing. In some of those implementations, the VADER framework can recover within a test-operate-test-exit loop with the help of other agents.

VADER FRAMEWORK

```
    Given: A set of agents [symbol] , a set of skills Σ^{(j)} with associated execution policies
Π^{(j)}, an outcome description function [symbol] _{Σ}, a task-instruction λ, and environmental state s₀
    1. Let cₙ be the task execution context update at planning step n.
    2. n = 1, c₀ = Ø
    3. while cₙ₋₁ ≠ “done” do
      # 1. Plan: Execution Skill selection using LMP
    4. σₙ = argmax_{σ}, p^{LMP} (σ|λ, sₙ, cₙ₋₁, ... , c₀)
      # Description of successful/failure outcomes of π_{σ},
    $5. {ℓ}_{n + 1}^{exp} = 𝒪 ( {σ}_{n} , {s}_{n} )$
      # 2. Execute: the skill by the robot itself or ask for help from an external agent.
State evolves to sₙ₊₁.
    $6. Execute {π}_{n}^{( j )} ( {s}_{n} ) in the environment$
      # 3. Detect: VQA context affordance
    $7. {ℓ}_{n + 1}^{a s s e s s} = arg {max}_{ℓ} {p}^{{v}_{Q A}} ( ℓ \vert {ℓ}_{n + 1}^{exp} , {s}_{n + 1} )$
      # LMP context update for replanning
    $8. {c}_{n} = concat ( {σ}_{n} , {ℓ}_{n + 1}^{exp} , {ℓ}_{n + 1}^{assess} )$
    9. n = n + 1
  10. end while
```

In some implementations, the robot detects its visual affordances and performs error recovery by replanning and/or asking for help from other agents (instead of executing a task plan given the library of skills Σ in an open-loop fashion). For example, the system can use a plan, execution, framework, with a seeking help skill as a recovery mechanism. While executing a plan, if the robot detects a deviation from its expectations (e.g., an object obstructing a table area to be wiped), it can replan for recovery, and upon receiving help, can complete the original plan.

(1) In some implementations, the system can plan the next primitive to be executed by selecting the skill σ from the library of skills Σ that satisfies one or more conditions (e.g., selecting the skill with the highest probability for success). For instance, the system can select the skill 6=“pick up soda can” for the robot. Additionally or alternatively, the system can generate a language description l^{exp}=“soda can in hand” for the expected desired future state if the execution was successful. (2) In some implementations, the system can execute the skill (e.g., the skill “pick up soda can”), resulting in a new state sₙ₊₁ when starting from sₙ. (3) In some implementations, the system can detect one or more deviations and/or errors by comparing the new state sₙ₊₁ with the expected description l^{exp}.

Deviations can include failures in skill execution, losing the capacity for executing the skill (for example, breaking a gripper), incorrectly picking up tasks it can't complete given its skillset, one or more skill execution failures and/or combinations thereof. In the case of skill failure, replanning (which can occur during the plan and/or execute phases) may bring the robot back to the desired state. In the case of loss of capacity and/or claiming an out-of-scope task, however, replanning may not be feasible: if unable to complete the task on its own, the agent may need to seek help from another robot and/or a human to recover (which occurs during the detect phase). In some implementations, the VADER framework thus enables a cooperative environment of robots with diverse skills sets or even morphologies sharing an ecosystem with humans.

As an illustrative example, the system can assume coexistence of agent variants A^{(j)}'s with diverse skill specializations Σ^{(j)}. For example, a first robot might have a gripper which can be used to pick up one or more objects, such as a soda can, while a second robot has a wiping tool at its end-effector allowing it to perform other types of skills such as wiping a table (but cannot pick up a soda with the wiping tool). The system can assume one or more humans have the ability to perform any of the skills needed for long-horizon tasks. In some of those implementations, to minimally disrupt the autonomy of the overall robotic system, the VADER framework prioritizes asking for help from other robots before asking for human intervention.

Given an LMP, the VADER framework provides three key components: (a) detection of skill affordances and execution errors with visual question answering, (b) replanning based on the detected categories of failures, and (c) recovery based on seeking help from other agents.

Note steps (a) and (b) are similar to closed-loop feedback techniques, with the additions that in (a) the system checks for skill affordance failures where a robot has taken on a skill it either cannot and/or has become unable to perform; detecting these out-of-scope failures informs the replanning choices in (b) to consider assistance from other agents via (c). Additionally or alternatively, asking for help on a failed skill can result in an entirely new task, which itself may require the execution of several skills for its completion. For instance, the wiping robot might realize it can't wipe when there is a soda can on the table. Asking for help will lead to another robot performing a long-horizon task of de-cluttering the table by navigating to it and picking up the soda can.

Task execution failures that VADER aims to recover from can be grouped broadly according to their causes: infeasible states; skill execution where the system thinks it was successful, but it failed; skill execution fails and alerts; erroneous planning; one or more additional or alternative types of task execution failures; and/or combinations thereof.

In some implementations, infeasible states are a common point of failure of long-horizon task execution. For example, a robot may break its gripper, be blocked on its path, subscribe to a task requiring a skill outside its capabilities, encounter one or more additional or alternative infeasible states, and/or combinations thereof. In some implementations, long-horizon task execution can fail when the system thinks the robot(s) successfully executed a skill, but the robot(s) actually failed in executing the skill. For example, while a robot is cleaning a table it might drop the debris due to a poor grip, but the manipulation policy may still finish normally. Additionally or alternatively, in some embodiments the skill execution policies can themselves able to sense failures in its execution and halt. For example, a navigation policy may declare infeasible in reach after exhausting all possible paths of approach unsuccessfully. In some implementations, task execution can fail due to erroneous planning. A wrong planning step chosen by LMP can put the execution on an undesirable path eventually making the robot fail. However, because VADER relies on the LMP for planning in the loop and has no access to the execution history or broader context, it cannot detect failures in planning.

In some implementations, VQA can be used by the system to estimate skill affordances in a closed-loop, policy-agnostic way—as opposed to estimating skill affordances based on RL policy value functions, which are mainly used for open-loop skill selection during planning, prior to execution, and may not be trivially available for BC or MPC. From the perspective of the VADER framework, value function affordances, if used at all, are considered to be implicitly embedded in p^{LMP}.

VQA-based affordance detection can be applied in a plug-and-play fashion using the current state and a language representation of the expected outcomes of the executed skill l^{exp}. The skill outcome description function responsible for generating natural language descriptions of the possible states sₙ₊₁ given successful or unsuccessful execution of a skill can be denoted by O:Σ×S→Λ. In some implementations, O could be a lookup table from skill descriptions to outcome descriptions. Additionally or alternatively, the LMP could be modified to output both the selected skill σₙ to be executed at sₙ and the expected outcome

$${l}_{n + 1}^{e x p}$$

at time step sₙ₊₁. If knowledge of the current state is required for this assessment, the same VQA used for estimating skill affordances can be used for assessing the expected outcome

$${l}_{n + 1}^{e x p}$$

by comparing the skill description σₙ with the current state sₙ.

From the perspective of the VADER framework, the output VQA is a language assessment of the last skill execution

$${l}_{n + 1}^{a s s e s s}$$

which can be appended to the skill σₙ and fed back to the LMP. In some implementations,

$${l}_{n + 1}^{a s s e s s}$$

can be computed over a fixed set of expected outcomes of skill execution over which the system picks the answer with the maximum score argmaxₗp^{VQA}(l, sₙ₊₁), as is the case in zero-shot VQA based on ViLD and/or CLIP. Additionally or alternatively, an open-set VQA system like PaLI could generate

$${l}_{n + 1}^{a s s e s s}$$

from the current state sₙ₊₁ based on a text query based on the expected outcomes

$${l}_{n + 1}^{e x p} .$$

In some implementations, for error detection, in the navigation example, the VQA prompt could be “is the robot at posA” applied to an image of the current localization state, and expected outcomes might include “{no, yes}” with “yes” denoting success. If the answers are scored “{no: 0.55, yes: 0.32, . . . }” then the assessed execution success of “navigate to destination posA”

$${l}_{n + 1}^{a s s e s s}$$

would be “no”, resulting on the LMP replanning to recover from failure on the next step.

In some implementations, for affordance detection, the system needs to check the precondition of an affordance prior to execution; this is performed by novel information-gathering skills and which the LMP can use to check the precognitions of the next skill. For example, a wiping robot may need the table to be clear of clutter prior to being wiped. In some implementations, the LMP may break the task “wipe the table” into the skills “drive to the table,” “check if the table is clear,” and “perform table wiping.” The skill “check if the table is clear” is an information gathering skill that checks the prerequisites for “perform table wiping” by looking at the table.

$${l}_{n + 1}^{e x p}$$

for this skill may be “is the table clear for wiping?” applied to the current camera image using an open-set VQA system like PaLI. If the answer is “no” then the prerequisite for the “perform table wiping” skill would fail and the LMP would replan by asking another agent to remove the clutter.

Replanning can absorb failures in the LMP. In some implementations, the previously selected skill σₙ is appended with the outcome

$${l}_{n + 1}^{e x p}$$

and the execution success assessment

$${l}_{n + 1}^{a s s e s s}$$

to form a new context prompt

$${c}_{n} := conca t ( {σ}_{n} , {l}_{n + 1}^{e x p} , {l}_{n + 1}^{a s s e s s} )$$

that is fed back to the LMP for replanning. For example, an LMP planned skill of “navigate to destination posA,” in case of failure would receive the context prompt as “navigate to destination posA. at posA? no.” In some of those implementations, the LMP may generate a new plan.

In some implementations, the VADER framework can allow the robot to recover by seeking help. In some implementations, a robot needs ways to recover from failures, preferably without intervention from the original task requester. However, recovering from failure without intervention from the original task requester does not mean that the robot cannot request help. In some implementations, the VADER framework can handle cases where a robot can recover by retrying the same task itself. Additionally or alternatively, in many practical scenarios it is neither desirable nor feasible for the robot to retry the same task itself. In some of those implementations, in the VADER framework a robot which halts during task execution can request help from a nearby human or from another robot. While we assume humans are so skilled that the environment always affords them completing any task, in order to preserve autonomy of the overall robotic system in aggregation, some implementations of the VADER framework can prioritize receiving help from another robot before asking a nearby human for help.

In some implementations, the system can use one or more vision models for human detection for the robot to seek help from a nearby human. The VADER framework can use the robot's native hardware and software capabilities for human entity and depth perception and does not assume any specific dependency. In some implementations, the VADER framework also does not assume human intent prediction capabilities essential for effective social interaction in crowded spaces. For example, the system can pick the nearest human to request help from. Additionally or alternatively, if the robot cannot detect a nearby human, it can use a Human Robot Fleet Orchestration Service (HRFS) to ask for help.

In some implementations, when seeking help from another robot, the system does not assume the proximal availability of another robot. Additionally or alternatively, a robot currently asking for help from others may later be accepting a request coming from elsewhere. To facilitate communication between a large fleet of robots, the system can use a Human Robot Fleet Orchestration Service (HRFS).

In some implementations, HRFS is a scalable, cloud-based, plug-and-play, real-time transactional communication service supporting multimodal communication among its participants. An agent can post tasks which can be claimed by one or more other agents. For example, a robot may push a task like “open the door,” potentially with an executor preference of “human.” The entire HRFS is agent agnostic and can readily accommodate a robot fleet of any size and variety, and many humans (teleoperators and/or in-person).

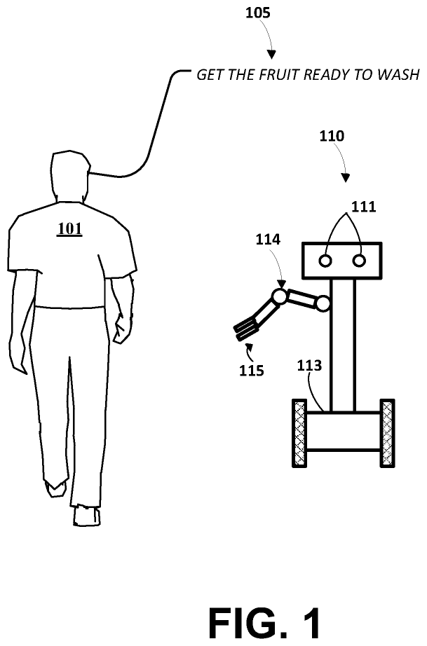

Turning now to the Figures, FIG. 1 illustrates an example of a human 101 providing a free-form (FF) natural language (NL) instruction 105 of “get the fruit ready to wash” to an example robot 110.

The robot 110 illustrated in FIG. 1 is a particular mobile robot. However, additional and/or alternative robots can be utilized with techniques disclosed herein, such as additional robots that vary in one or more respects from robot 110 illustrated in FIG. 1. For example, a mobile forklift robot, an unmanned aerial vehicle (“UAV”), a non-mobile robot, and/or a humanoid robot can be utilized instead of or in addition to robot 110, in techniques described herein.

Robot 110 includes a base 113 with wheels provided on opposed sides thereof for locomotion of the robot 110. The base 113 may include, for example, one or more motors for driving the wheels of the robot 110 to achieve a desired direction, velocity, and/or acceleration of movement for the robot 110. The robot 110 also includes robot arm 114 with an end effector 115 that takes the form of a gripper with two opposing “fingers” or “digits.” In some implementations, robot 110 can include one or more additional or alternative end effectors, such as a grasping end effector, a wiping end effector, a screwdriver end effector, one or more additional or alternative end effectors, and/or combinations thereof.

Robot 110 also includes a vision component 111 that can generate vision data (e.g., images) related to shape, color, depth, and/or other features of object(s) that are in the line of sight of the vision component 111. The vision component 111 can be, for example, a monocular camera, a stereographic camera (active or passive), and/or a 3D laser scanner. A 3D laser scanner can include one or more lasers that emit light and one or more sensors that collect data related to reflections of the emitted light. The 3D laser scanner can generate vision component data that is a 3D point cloud with each of the points of the 3D point cloud defining a position of a point of a surface in 3D space. A monocular camera can include a single sensor (e.g., a charge-coupled device (CCD)), and generate, based on physical properties sensed by the sensor, images that each includes a plurality of data points defining color values and/or grayscale values. For instance, the monocular camera can generate images that include red, blue, and/or green channels. Each channel can define a value for each of a plurality of pixels of the image such as a value from 0 to 255 for each of the pixels of the image. A stereographic camera can include two or more sensors, each at a different vantage point. In some of those implementations, the stereographic camera generates, based on characteristics sensed by the two sensors, images that each includes a plurality of data points defining depth values and color values and/or grayscale values. For example, the stereographic camera can generate images that include a depth channel and red, blue, and/or green channels.

Robot 110 also includes one or more processors that, for example: process FF NL input and map data to determine object descriptor(s) relevant to a robotic task of the FF NL input; determine, based on the FF NL input and the object descriptor(s), robotic skill(s) for performing the robotic task; control a robot, during performance of the robotic task, based on the determined robotic skill(s); etc. For example, one or more processors of robot 110 can implement all or aspects of process 300, 400, and/or 500 described herein. Additional description of some examples of the structure and functionality of various robots is provided herein.

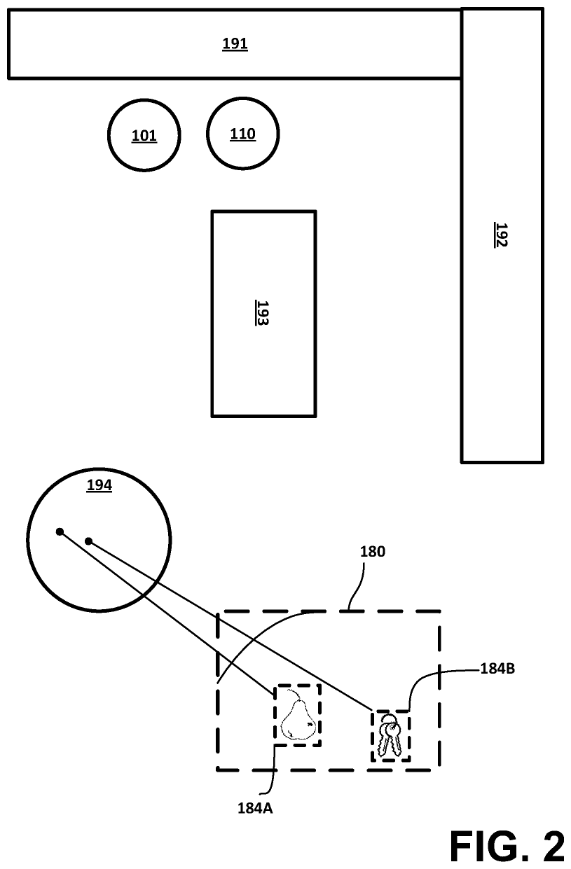

Turning now to FIG. 2, a simplified birds-eye view of an example environment, in which the human 101 and the robot 110 of FIG. 1 are located, is illustrated. The human 101 and the robot 110 are represented as circles in FIG. 2. Further, environmental features 191, 192, 193, and 194 are illustrated in FIG. 2. The environmental features 191, 192, 193, and 194 illustrate outlines of landmarks in the environment. For example, the environment could be an office kitchen or a work kitchen, and features 191 and 192 can be countertops, feature 193 can be a kitchen island, and feature 194 can be a round table.

Also illustrated in FIG. 2 is an example vision data instance 180 that was captured in the environment. For example, robot 110 may have captured the vision data instance 180, using vision component 111, during a previous exploration of the environment of FIG. 2. Additionally or alternatively, robot 110 may have captured the vision data instance 180, using vision component 111, subsequent to robot 110 performing one or more sub-tasks in the environment of FIG. 2. In the illustrated example, the vision data instance 180 captures a pear 184A and keys 184B that are both present on the round table represented by feature 194. It is noted that, in some implementations, the view of the pear, the keys, and other objects of the environment is illustrated as a birds-eye view for the sake of simplicity.

In some implementations, the free-form (FF) natural language (NL) instruction 105 of “get the fruit ready to wash” can be processed using a large language model (LLM) to generate LLM output dependent on the instruction, where the LLM output indicates one or more sub-tasks for performing the task of “get the fruit ready to wash”. For example, the LLM output can indicate the sub-tasks of “navigate to the table” and “pick up the fruit.” Additionally or alternatively, the system can generate a visual language model (VLM) prompt based on the LLM output. For example, based on the LLM output of the sub-tasks “navigate to the table” and “pick up the fruit,” the system can generate the VLM prompt of “is there fruit on the table.”

In some implementations, the system can process the instance of vision data 180 and the VLM prompt using the VLM to generate a task conditioned description of the environment. For example, the system can process the instance of vision data 180 and the VLM prompt of “is there fruit on the table” to generate a task conditioned description of the environment indicating there is a pear 184A on the table 194. Additionally or alternatively, the system can process the task conditioned description of the environment and the instruction using the LLM to generate refined LLM output. The refined LLM output can indicate one or more refined sub-tasks for performing the task. For example, the system can process the instruction of “get the fruit ready to wash” and the task conditioned description of the environment indicating there is a pear 184A on the table 194 to generate refined LLM output. In the illustrated example, the refined LLM output can indicate the refined sub-tasks of “navigate to the table” and “pick up the pear.” In other words the refined LLM output indicates a refined sub-task of “picking up the pear” based on the pear 184A captured in the instance of vision data 180 in place of the sub-task “pick up the fruit” indicated in the LLM output before refinement. Only a single vision data instance is illustrated in FIG. 2 for sake of simplicity. However, it is noted that many additional vision data instances can be captured in the environment for utilization in techniques disclosed herein.

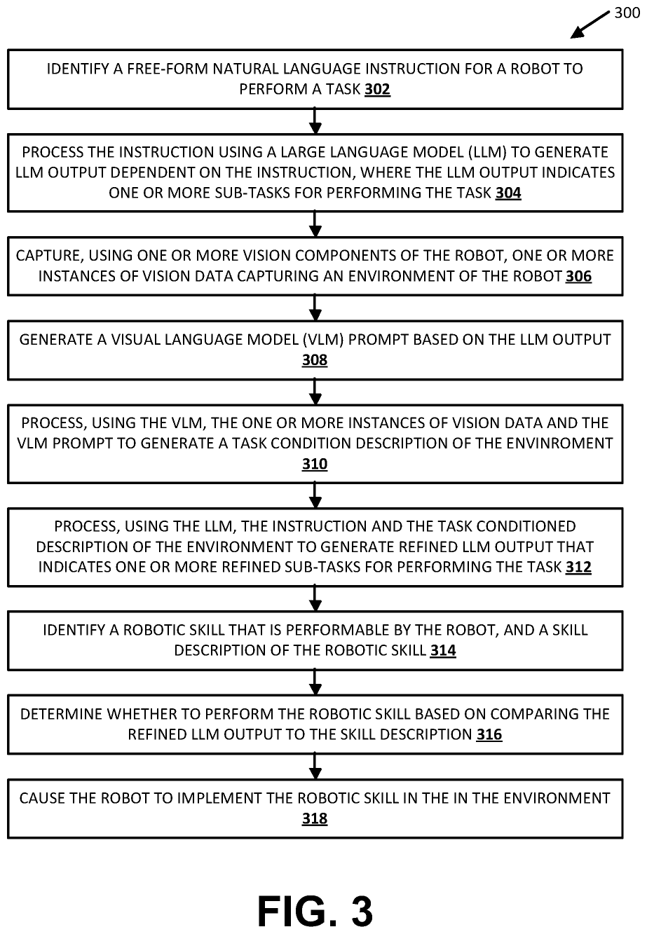

FIG. 3 is a flowchart illustrating an example process 300 of causing a robot to implement a robotic skill using a LLM and a VLM in accordance with various implementations described herein. For convenience, the operations of the process 300 are described with reference to a system that performs the operations. This system can include one or more components of a robot, such as a robot processor and/or robot control system of robot 110, robot 620, and/or other robot and/or can include one or more components of a computer system, such as computer system 710. Moreover, while operations of process 300 are shown in a particular order, this is not meant to be limiting. One or more operations can be reordered, omitted, or added.

At block 302, the system identifies a free-form natural language instruction for a robot to perform a task. For example, the system can identify the FF NL instruction 105 of “get the fruit ready to wash” and the robot 110 as described herein with respect to FIG. 1.

At block 304, the system processes the instruction using a large language model (LLM) to generate LLM output dependent on the instruction. In some implementations, the LLM output one or more sub-tasks for performing the task. For example, the system can process the instruction of “get the fruit ready to wash” using the LLM to generate LLM output indicating the sub-tasks of “navigate to the table” and “pick up the fruit” as described herein with respect to FIG. 2.

At block 306, the system captures one or more instances of vision data capturing an environment of the robot. In some implementations, the one or more instances of vision data can be captured using one or more vision components of the robot. In some of those implementations, at least one of the one or more vision components of the robot can be affixed to the robot. In some other implementations, at least one of the one or more vision components of the robot can be a vision component in the environment with the robot (e.g., a camera mounted overhead in the environment capturing at least a portion of the robot and/or at least a portion of the environment). For example, the system can capture the instance of vision data 180 using vision component 111 as described herein with respect to FIG. 1 and FIG. 2.

At block 308, the system generates a VLM prompt based on the LLM output. In some implementations, the VLM prompt can be based on one or more sub-tasks identified in the LLM output. Additionally or alternatively, the VLM prompt can be based on one or more sub-tasks the robot has previously attempted to perform. For example, based on the LLM output of the sub-tasks “navigate to the table” and “pick up the fruit,” the system can generate the VLM prompt of “is there fruit on the table” as described herein with respect to FIG. 2.

At block 310, the system processes, using the VLM, the one or more instances of vision data and the VLM prompt to generate a task conditioned description of the environment. For example, the system can process the instance of vision data 180 and the VLM prompt of “is there fruit on the table” to generate a task conditioned description of the environment indicating there is a pear 184A on the table 194 as described herein with respect to FIG. 2.

At block 312, the system can process, using the LLM, the instruction and the task conditioned description of the environment to generate refined LLM output. In some implementations, the refined LLM output indicates one or more refined sub-tasks for performing the task. For example, as described herein with respect to FIG. 2, the system can process the instruction of “get the fruit ready to wash” and the task conditioned description of the environment indicating there is a pear 184A on the table 194 to generate refined LLM output. In the illustrated example, the refined LLM output can indicate the refined sub-tasks of “navigate to the table” and “pick up the pear.” In other words the refined LLM output indicates a refined sub-task of “picking up the pear” based on the pear 184A captured in the instance of vision data 180 in place of the sub-task “pick up the fruit” indicated in the LLM output before refinement.

At block 314, the system can identify a robotic skill that is performable by the robot and a skill description of the robotic skill. For example, the system can identify a navigation skill with a corresponding skill description of “move forward to the table.”

At block 316, the system can determine whether to perform the robotic skill based on comparing the refined LLM output to the skill description. For example, the system can compare the refined LLM output indicating the refined sub-tasks of “navigate to the table” and “pick up the pear” with the skill description of “move forward to the table.” In some implementations, the system can determine to perform the robotic skill based on the comparing. In some other implementations, the system can determine to not perform the robotic skill based on the comparing.

At block 318, when the system determines to perform the robotic skill at block 316, the system can cause the robot to implement the robotic skill in the environment. For example, the system can cause the robot to perform the navigation skill based on the comparing.

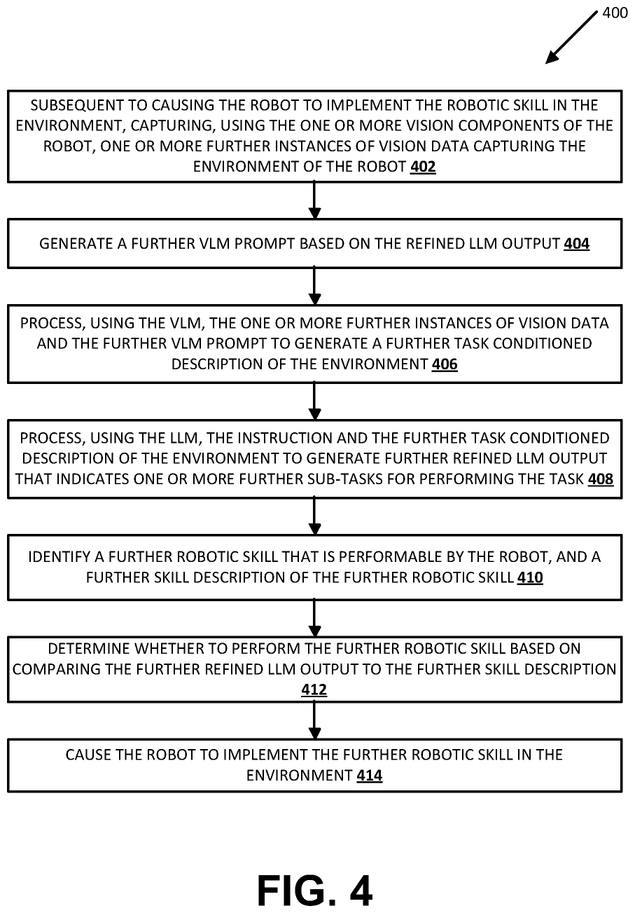

FIG. 4 is a flowchart illustrating an example process 400 of causing a robot to implement a robotic skill using a LLM and a VLM in accordance with various implementations described herein. For convenience, the operations of the process 400 are described with reference to a system that performs the operations. This system can include one or more components of a robot, such as a robot processor and/or robot control system of robot 110, robot 620, and/or other robot and/or can include one or more components of a computer system, such as computer system 710. Moreover, while operations of process 400 are shown in a particular order, this is not meant to be limiting. One or more operations can be reordered, omitted, or added.

At block 402, subsequent to causing the robot to implement the robotic skill in the environment, the system captures one or more further instances of vision data capturing the environment of the robot. In some implementations, subsequent to causing the robotic task of navigating described herein with respect to block 318, the system can capture one or more further instances of vision data. In some implementations, the one or more further instances of vision data can be captured by robot 110 using vision component 111 as described herein with respect to FIG. 1. In some implementations, the one or more further instances of vision data can be captured while the robot is still implementing the robotic skill. In some implementations, causing the robot to implement the robotic skill includes causing the robot to successfully perform the robotic skill. In some other implementations, causing the robot to implement the robotic skill includes causing the robot to begin performing the robotic skill where the robot is unsuccessful in performing the robotic skill.

At block 404, the system generates a further VLM prompt based on the refined LLM output. For example, the system can generate a further VLM prompt of “have I moved to the table” based on the refined LLM output indicating the refined sub-tasks of “navigate to the table” and “pick up the pear” as described herein with respect to block 312 of process 300.

At block 406, the system can process, using the VLM, the one or more further instances of vision data and the further VLM prompt to generate a further task conditioned description of the environment. For example, the system can process the further VLM prompt of “have I moved to the table” along with the one or more further instances of vision data to generate a further task conditioned description of the environment. In the illustrated example, the further task conditioned description of the environment indicating the robot has moved to the table 194 as described herein with respect to FIG. 2.

At block 408, the system can process, using the LLM, the instruction and the further task conditioned description of the environment to generate further refined LLM output that indicates one or more further sub-tasks for performing the task. For example, the system can process, using the LLM, the instruction of “get the fruit ready to wash” (as described herein with respect to block 302 of process 300) and the further task conditioned description of the environment indicating the robot has moved to the table (as described herein with respect to block 406) to generate further refined LLM output. In the illustrated example, the further refined LLM output can indicate the one or more further sub-tasks of “pick up the pear” and “navigate the robot with the pear to the sink.”

At block 410, the system identifies a further robotic skill that is performable by the robot, and a further skill description of the further robotic skill. For example, the system can identify a further robotic skill of grasping an object with a further robotic skill description of “pick up the object.”

At block 412, the system determines whether to perform the further robotic skill based on comparing the further refined LLM output to the further skill description. For example, the system can compare the further refined LLM output indicating the one or more further sub-tasks of “pick up the pear” and “navigate the robot with the pear to the sink” with the further robotic skill description of “pick up the object”.

At block 414, the system can cause the robot to implement the further robotic skill in the environment. For example, the system can cause the robot to implement the further robotic skill of grasping the object to pick up the pear.

In some implementations, the process of capturing one or more further instances of vision data captured subsequent to the system causing the robot to implement the further robotic skill, generating a further VLM prompt based on the previous instance of refined LLM output, generating a further task conditioned description of the environment based on the one or more further instances of vision data and the further VLM prompt, and determining whether to implement a further robotic skill based on the instruction and the further task conditioned description of the environment can repeat one or more additional iterations. For example, the process can repeat until the robot completes the robotic task, until a threshold value of time has elapsed, until the robot can perform no further skills, one or more additional or alternative conditions, and/or combinations thereof.

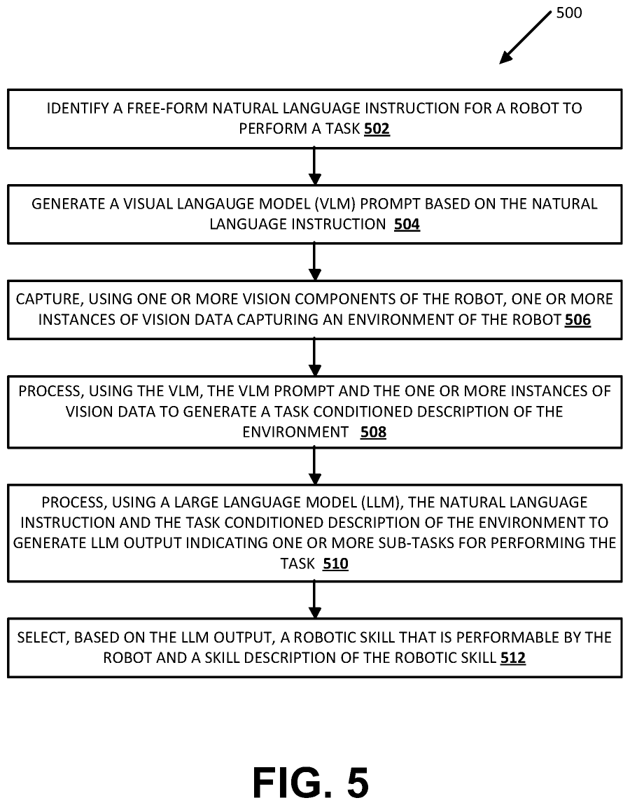

FIG. 5 is a flowchart illustrating an example process 500 of selecting a robotic skill that is performable by a robot based on LLM output and a skill description of the robotic skill in accordance with various implementations described herein. For convenience, the operations of the process 500 are described with reference to a system that performs the operations. This system can include one or more components of a robot, such as a robot processor and/or robot control system of robot 110, robot 620, and/or other robot and/or can include one or more components of a computer system, such as computer system 710. Moreover, while operations of process 500 are shown in a particular order, this is not meant to be limiting. One or more operations can be reordered, omitted, or added.

At block 502, the system identifies a free-form natural language instruction for a robot to perform a task. For example, the system can identify the FF NL instruction 105 of “get the fruit ready to wash” and the robot 110 as described herein with respect to FIG. 1.

At block 504, the system can generate a visual language model (VLM) prompt based on the natural language instruction. For example, the system can generate a VLM prompt of “is there fruit on the table” based on the NL instructions of “get the fruit ready to wash.”

At block 506, the system can capture, using one or more vision components of the robot, one or more instances of vision data capturing an environment of the robot. In some implementations, the one or more instances of vision data can be captured using one or more vision components of the robot. In some of those implementations, at least one of the one or more vision components of the robot can be affixed to the robot. In some other implementations, at least one of the one or more vision components of the robot can be a vision component in the environment with the robot (e.g., a camera mounted overhead in the environment capturing at least a portion of the robot and/or at least a portion of the environment). For example, the system can capture the instance of vision data 180 using vision component 111 as described herein with respect to FIG. 1 and FIG. 2.

At block 508, the system processes, using the VLM, the VLM prompt and the one or more instances of vision data to generate a task conditioned description of the environment. For example, the system can process the VLM prompt of “can I pick up a piece of fruit” and the one or more instances of vision data to generate the task conditioned description of the environment. In some implementations, the robot can perform a self inspection based on the one or more instances of vision data and can determine that it has a grasping end effector that can pick up a small object. When the system identifies the robot has a grasping end effector that can pick up small objects, the system can generate the task conditioned description of the environment of “I have a grasping end effector.” Additionally or alternatively, the robot can perform a self inspection based on the one or more instances of vision data and can determine that the robot does not have a grasping end effector and is unable to pick up the piece of fruit. When the system identifies the robot does not have a grasping end effector and cannot pick up the piece of fruit, the system can generate the task conditioned description of the environment of “I do not have a grasping end effector.”

At block 510, the system processes, using a large language model (LLM), the natural language instruction and the task conditioned description of the environment to generate LLM output indicating one or more sub-tasks for performing the task. For example, when the robot has a grasping end effector, the system can process, using the LLM, the NL instruction of “get the fruit ready to wash” and the task conditioned description of the environment of “I have an end effector” to generate LLM output indicating the sub-tasks of “navigate to the table” and “pick up the fruit”. Additionally or alternatively, when the robot does not have a grasping end effector, the system can process, using the LLM, the NL instruction of “get the fruit ready to wash” and the task conditioned description of the environment of “I do not have a grasping end effector” to generate LLM output indicating the sub-task of “ask a robot with a grasping end effector to help”.

At block 512, based on the LLM output, the system selects a robotic skill that is performable by the robot and a skill description of the robotic skill. For example, based on the LLM output indicating the sub-tasks of “navigate to the table” and “pick up the fruit” the system can select a robotic grasping skill with the skill description of “I can pick up small objects.” The system, based on comparing the skill description of “I can pick up small objects” with the LLM output indicating the sub-tasks of “navigate to the table” and “pick up the fruit” to perform the robotic grasping skill. Additionally or alternatively, based on the LLM output indicating the sub-task of “ask a robot with a grasping end effector to help,” the select a robotic skill of requesting assistance from an additional robot with a skill description of “transmit a message to another robot for help.” The system, based on comparing the skill description of “transmit a message to another robot for help” with the LLM output indicating the sub-task of “ask a robot with a grasping end effector to help” to perform the robotic skill of requesting assistance from another robot. In some of those implementations, the additional robot that can pick up the piece of fruit can then continue implementing the task of “get the fruit ready to wash.”

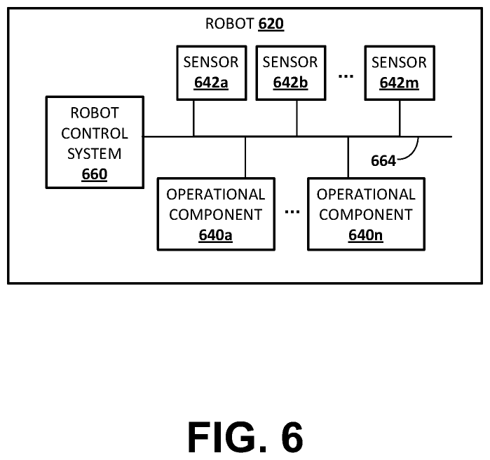

FIG. 6 schematically depicts an example architecture of a robot 620. The robot 620 includes a robot control system 660, one or more operational components 640a-640n, and one or more sensors 642a-642m. The sensors 642a-642m may include, for example, vision sensors, light sensors, pressure sensors, pressure wave sensors (e.g., microphones), proximity sensors, accelerometers, gyroscopes, thermometers, barometers, and so forth. While sensors 642a-m are depicted as being integral with robot 620, this is not meant to be limiting. In some implementations, sensors 642a-m may be located external to robot 620, e.g., as standalone units.

Operational components 640a-640n may include, for example, one or more end effectors and/or one or more servo motors or other actuators to effectuate movement of one or more components of the robot. For example, the robot 620 may have multiple degrees of freedom and each of the actuators may control the actuation of the robot 620 within one or more of the degrees of freedom responsive to the control commands. As used herein, the term actuator encompasses a mechanical or electrical device that creates motion (e.g., a motor), in addition to any driver(s) that may be associated with the actuator and that translate received control commands into one or more signals for driving the actuator. Accordingly, providing a control command to an actuator may comprise providing the control command to a driver that translates the control command into appropriate signals for driving an electrical or mechanical device to create desired motion.

The robot control system 660 may be implemented in one or more processors, such as a CPU, GPU, and/or other controller(s) of the robot 620. In some implementations, the robot 620 may comprise a “brain box” that may include all or aspects of the control system 660. For example, the brain box may provide real time bursts of data to the operational components 640a-n, with each of the real time bursts comprising a set of one or more control commands that dictate, inter alia, the parameters of motion (if any) for each of one or more of the operational components 640a-n. In some implementations, the robot control system 660 may perform one or more aspects of method(s) described herein, such as process 300 of FIG. 3, process 400 of FIG. 4, and/or process 500 of FIG. 5.

As described herein, in some implementations all or aspects of the control commands generated by control system 660, in controlling a robot during performance of a robotic task, can be generated based on robotic skill(s) determined to be relevant for the robotic task and, optionally, based on determined map location(s) for environmental object(s). Although control system 660 is illustrated in FIG. 6 as an integral part of the robot 620, in some implementations, all or aspects of the control system 660 may be implemented in a component that is separate from, but in communication with, robot 620. For example, all or aspects of control system 660 may be implemented on one or more computing devices that are in wired and/or wireless communication with the robot 620, such as computing device 710.

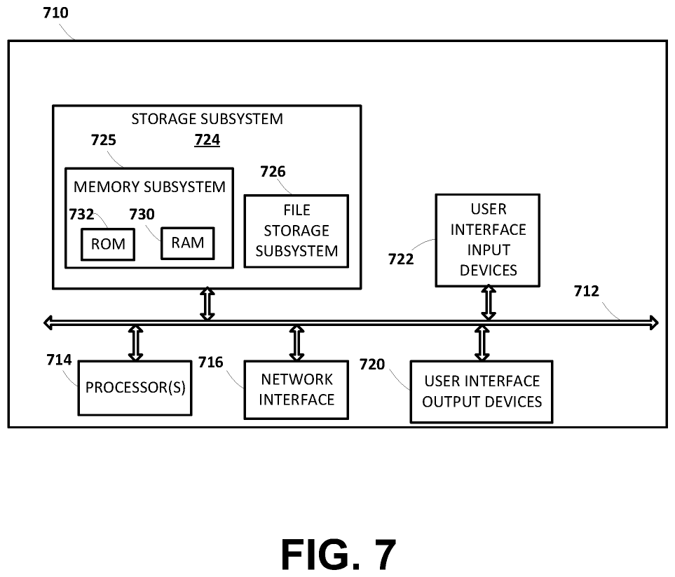

FIG. 7 is a block diagram of an example computing device 710 that may optionally be utilized to perform one or more aspects of techniques described herein. Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the method 200 of FIG. 2, the method 300 of FIG. 3, the method 400 of FIG. 4, and/or the method 500 of FIG. 5.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple buses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In some implementations, a method implemented by one or more processors is provided, the method includes identifying an instruction for a robot to perform a task, the instruction being a free-form natural language instruction. In some implementations, the method includes processing the instruction, using a generative model, to generate natural language text output that is dependent on the instruction and that indicates one or more sub-tasks for performing the task. In some implementations, the method includes capturing, using one or more vision components of the robot, one or more instances of vision data capturing an environment of the robot. In some implementations, the method includes generating a visual language model (VLM) prompt based on the natural language text output. In some implementations, the method includes processing, using the VLM, the one or more instances of vision data and the VLM prompt to generate a task conditioned description of the environment. In some implementations, the method includes processing, using the generative model, the instruction and the task conditioned description of the environment to generate refined natural language text output that indicates one or more refined sub-tasks for performing the task. In some implementations, the method includes identifying a robotic skill that is performable by the robot, and a skill description of the robotic skill. In some implementations, the method includes determining, based on comparing the refined natural language text output to the skill description, to implement the robotic skill. In some implementations, in response to determining to implement the robotic skill, the method includes causing the robot to implement the robotic skill in the environment.

These and other implementations of the technology can include one or more of the following features.

In some implementations, subsequent to causing the robot to implement the robotic skill in the environment, the method further includes capturing, using the one or more vision components of the robot, one or more further instances of vision data capturing the environment of the robot. In some implementations, the method further includes generating a further VLM prompt based on the refined natural language text output. In some implementations, the method further includes processing, using the VLM, the one or more further instances of vision data and the further VLM prompt to generate a further task conditioned description of the environment. In some implementations, the method further includes processing, using the generative model, the instruction and the further task conditioned description of the environment to generate further refined natural language output that indicates one or more further sub-tasks for performing the task. In some implementations, the method further includes identifying a further robotic skill that is performable by the robot, and a further skill description of the robotic skill. In some implementations, the method further includes determining, based on comparing the further refined natural language text output to the further skill description, to implement the further robotic skill. In some implementations, in response to determining to implement the further robotic skill, the method further includes causing the robot to implement the further robotic skill in the environment.

In some implementations, the further task conditioned description of the environment indicates the robot was not successful in implementing the robotic skill. In some of those implementations, the further robotic skill is identified based on the further task conditioned description of the environment indicating the robot was not successful in implementing the robotic skill. In some of those implementations, the further robotic skill would not have been identified if the further task conditioned description of the environment indicated the robot successfully implemented the robotic skill.

In some implementations, the further robotic skill includes transmitting robotic skill output to an additional robot, and wherein the robotic skill output causes the additional robot to implement the robotic skill.

In some implementations, the further task conditioned description of the environment indicates the robot was successful in implementing the robotic skill. In some of those implementations, the further robotic skill is identified based on the further task conditioned description of the environment indicating the robot was successful in implementing the robotic skill. In some of those implementations, the further robotic skill would not have been identified if the further task conditioned description of the environment indicated the robot did not successfully implement the robotic skill.

In some implementations, the generative model is a large language model (LLM).

In some implementations, the free-form natural language instruction is generated based on user interface input that is provided by a user via one or more user interface input devices.

In some implementations, the VLM includes an encoder that maps the one or more instances of vision data capturing the environment of the robot and the VLM prompt to a shared embedding space.

In some implementations, a method implemented by one or more processors is provided, the method includes identifying a free-form natural language instruction for a robot to perform a task. In some implementations, the method includes generating a visual language model (VLM) prompt based on the natural language instruction. In some implementations, the method includes capturing, using one or more vision components of the robot, one or more instances of vision data capturing an environment of the robot. In some implementations, the method includes processing, using the VLM, the VLM prompt and the one or more instances of vision data to generate a task conditioned description of the environment. In some implementations, the method includes processing, using a generative model, the natural language instruction and the task conditioned description of the environment to generate natural language text output indicating one or more sub-tasks for performing the task. In some implementations, the method includes selecting, based on the natural language text output, a robotic skill is performable by the robot and a skill description of the robotic skill.

These and other implementations of the technology can include one or more of the following features.

In some implementations, performance of the task includes the robot using one or more task end effectors. In some of those implementations, the one or more instances of vision data capture one or more available end effectors of the robot. In some of those implementations, the task conditioned description of the environment includes an indication of whether the one or more available end effectors include the one or more task end effectors. In some versions of those implementations, the task conditioned description of the environment indicates the one or more available end effectors includes the one or more task end effectors. In some versions of those implementations, the one or more sub-tasks for performing the task indicated by the natural language text output includes a navigation sub-task.

In some implementations, the one or more sub-tasks for performing the task indicated by the natural language text output includes an end effector sub-task manipulating the one or more task end effectors included in the one or more available end effectors. In some versions of those implementations, the task conditioned description of the environment indicates the one or more available end effectors does not include the one or more task end effectors. In some versions of those implementations, the one or more sub-tasks for performing the task indicated by the LLM output includes transmitting a message to one or more additional robots with the one or more task end effectors, and wherein the message requests the one or more additional robots perform one or more actions in furtherance of performing the task.

In some implementations, the generative model is a large language model.

Other implementations can include a non-transitory computer readable storage medium storing instructions executable by one or more processor(s) (e.g., a central processing unit(s) (CPU(s)), graphics processing unit(s) (GPU(s)), and/or tensor processing unit(s) (TPU(s))) to perform a method such as one or more of the methods described herein. Yet other implementations can include a system of one or more computers and/or one or more robots that include one or more processors operable to execute stored instructions to perform a method such as one or more of the methods described herein.

1. A method implemented by one or more processors, the method comprising:
identifying an instruction for a robot to perform a task, the instruction being a free-form natural language instruction;
processing the instruction, using a generative model, to generate natural language text output that is dependent on the instruction and that indicates one or more sub-tasks for performing the task;
capturing, using one or more vision components of the robot, one or more instances of vision data capturing an environment of the robot;
generating a visual language model (VLM) prompt based on the natural language text output;
processing, using the VLM, the one or more instances of vision data and the VLM prompt to generate a task conditioned description of the environment;
processing, using the generative model, the instruction and the task conditioned description of the environment to generate refined natural language text output that indicates one or more refined sub-tasks for performing the task;
identifying a robotic skill that is performable by the robot, and a skill description of the robotic skill;
determining, based on comparing the refined natural language text output to the skill description, to implement the robotic skill; and
in response to determining to implement the robotic skill:
causing the robot to implement the robotic skill in the environment.

2. The method of claim 1, further comprising, subsequent to causing the robot to implement the robotic skill in the environment:
capturing, using the one or more vision components of the robot, one or more further instances of vision data capturing the environment of the robot;
generating a further VLM prompt based on the refined natural language text output;
processing, using the VLM, the one or more further instances of vision data and the further VLM prompt to generate a further task conditioned description of the environment;
processing, using the generative model, the instruction and the further task conditioned description of the environment to generate further refined natural language output that indicates one or more further sub-tasks for performing the task;
identifying a further robotic skill that is performable by the robot, and a further skill description of the robotic skill;
determining, based on comparing the further refined natural language text output to the further skill description, to implement the further robotic skill; and
in response to determining to implement the further robotic skill:
causing the robot to implement the further robotic skill in the environment.

3. The method of claim 1, wherein the further task conditioned description of the environment indicates the robot was not successful in implementing the robotic skill, wherein the further robotic skill is identified based on the further task conditioned description of the environment indicating the robot was not successful in implementing the robotic skill, and wherein the further robotic skill would not have been identified if the further task conditioned description of the environment indicated the robot successfully implemented the robotic skill.

4. The method of claim 1, wherein the further robotic skill includes transmitting robotic skill output to an additional robot, and wherein the robotic skill output causes the additional robot to implement the robotic skill.

5. The method of claim 1, wherein the further task conditioned description of the environment indicates the robot was successful in implementing the robotic skill, wherein the further robotic skill is identified based on the further task conditioned description of the environment indicating the robot was successful in implementing the robotic skill, and wherein the further robotic skill would not have been identified if the further task conditioned description of the environment indicated the robot did not successfully implement the robotic skill.

6. The method of claim 1, wherein the generative model is a large language model (LLM).

7. The method of claim 1, wherein the free-form natural language instruction is generated based on user interface input that is provided by a user via one or more user interface input devices.

8. The method of claim 1, where the VLM includes an encoder that maps the one or more instances of vision data capturing the environment of the robot and the VLM prompt to a shared embedding space.

9. A method implemented by one or more processors, the method comprising:
identifying a free-form natural language instruction for a robot to perform a task;
generating a visual language model (VLM) prompt based on the natural language instruction;
capturing, using one or more vision components of the robot, one or more instances of vision data capturing an environment of the robot;
processing, using the VLM, the VLM prompt and the one or more instances of vision data to generate a task conditioned description of the environment;
processing, using a generative model, the natural language instruction and the task conditioned description of the environment to generate natural language text output indicating one or more sub-tasks for performing the task; and
selecting, based on the natural language text output, a robotic skill is performable by the robot and a skill description of the robotic skill.

10. The method of claim 9, wherein performance of the task includes the robot using one or more task end effectors, wherein the one or more instances of vision data capture one or more available end effectors of the robot, wherein the task conditioned description of the environment includes an indication of whether the one or more available end effectors include the one or more task end effectors.

11. The method of claim 10, wherein the task conditioned description of the environment indicates the one or more available end effectors includes the one or more task end effectors.

12. The method of claim 9, wherein the one or more sub-tasks for performing the task indicated by the natural language text output includes a navigation sub-task.

13. The method of claim 9, wherein the one or more sub-tasks for performing the task indicated by the natural language text output includes an end effector sub-task manipulating the one or more task end effectors included in the one or more available end effectors.

14. The method of claim 10, wherein the task conditioned description of the environment indicates the one or more available end effectors does not include the one or more task end effectors.

15. The method of claim 14, wherein the one or more sub-tasks for performing the task indicated by the LLM output includes transmitting a message to one or more additional robots with the one or more task end effectors, and wherein the message requests the one or more additional robots perform one or more actions in furtherance of performing the task.

16. The method of claim 9, wherein the generative model is a large language model.

17. (canceled)

18. A robot including one or more processors that execute instructions, stored in memory of the client device, to:
identify an instruction for a robot to perform a task, the instruction being a free-form natural language instruction;
process the instruction, using a generative model, to generate natural language text output that is dependent on the instruction and that indicates one or more sub-tasks for performing the task;
capture, using one or more vision components of the robot, one or more instances of vision data capturing an environment of the robot;
generate a visual language model (VLM) prompt based on the natural language text output;
process, using the VLM, the one or more instances of vision data and the VLM prompt to generate a task conditioned description of the environment;
process, using the generative model, the instruction and the task conditioned description of the environment to generate refined natural language text output that indicates one or more refined sub-tasks for performing the task;
identify a robotic skill that is performable by the robot, and a skill description of the robotic skill;
determine, based on comparing the refined natural language text output to the skill description, to implement the robotic skill; and
in response to the determination to implement the robotic skill:
cause the robot to implement the robotic skill in the environment.

19. (canceled)
